(19) United States
(12) Patent Application Publication
(10) Pub. No.: US 2005/0181350 A1
(43) Pub. Date: Aug. 18, 2005

(54) Pattern of medical words and terms

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 10/780,230

(22) Filed: Feb. 18, 2004

(51) Int. Cl. G06F 17/30; G06F 7/00; G09B 23/28; G09B 25/00

(52) U.S. Cl. 434/367

(57) ABSTRACT

An intelligent system of pattern and hierarchies of series, groups, groupings, indexings and matrices of medical words, phrases, terms and terminologies relating to an illness, a disease, a disorder, symptoms and signs intelligently adaptable to render the comparisions, linkings, matchings and sortings of a layperson's words, phrases, terms and terminologies to certain or specific medical words, phrases, terms and terminologies and to certain group, grouping or index in the above series, groups, groupings, indexings and matrices and vice versa.

### FIELD OF INVENTION

Hierarchies of medical words and terms.

### BACKGROUND OF THE INVENTION

U.S. Pat. No. 6,132,218 entitled Images for Communication of Medical Information in Computer granted on Oct. 17, 2000 to this appliant, a first pending application entitled the Best American Healthcare System, docket number ABA 208, filed Dec. 17, 2002, a second pending application entitled A Method of Modulating Health-care Expenses, docket number ABA 0104, filed Jan. 12, 2004, and an abandoned application, docket number ABA207, entitled the Best Healthcare System filed Nov. 18, 2002 represent this applicant's continual quest to solve the current health-care crisis and improve people's health, quality of life and standard of living.

The thinkings and thought processes of the health-care consumers and buyers and physicians have always been and are distinctively different and of two different polarities. Consequently, there are constant conflicts among said people resulting in the horrendous health-care crisis. Prior to this patent application, neither solution nor means are available to resolve said difference. Therefore, the foremost objective of the present invention is to rid of or resolve said difference.

### SUMMARY OF THE INVENTION

In health-care, lay people who are the consumers and buyers of the services and physicians have different thought processes and, consequently, there are constant conflicts among lay people and between lay people and physicians.

The present invention is a system permitting or conferring on a lay individual or lay people the ability to perform intellectual tasks or processes relating to their own health-care.

The present invention is an intelligent system comprising a unique pattern and hierarchies of medical words, phrases, terms and terminologies relating to health, illnesses, diseases and disorders of humans or animals wherein a plurality of series, groups, groupings, indexings and matrices of medical words, phrases, terms and terminology intelligently adaptable to render the comparisions, linkings, matchings and sortings of a layperson's or novice's word or words, phrase or phrases, term or terms and terminology or terminologies relating to an illness, a disease, a disorder, symptoms and signs to certain or specific medical words, phrases, terms and terminologies in and to certain group, grouping or index in said plurality of series, groups, groupings, indexings and matrices and vice versa. The present invention intelligently adaptable to refer and link to and retrieve certain and specific word, words, phrase, phrases, term, terminology, terminologies, group, grouping and/or index in said series, groups, groupings, indexings and matrices for a layperson.

### DESCRIPTION OF THE PREFERRED EMBODIMENTS

The present invention of this physician applicant comprises a system of medical words, phrases, terms and terminologies adaptable to uniquely permit and confer on a lay individual or lay people the ability to perform intellectual tasks and processes relating to health-care. Certain organization and structure of a vast body of medical information and knowledge exclusively known to this physician form the products and outcomes of the present invention.

Said system comprises a vast collection of medical words, phrases, terms, terminology and terminologies relating to health, illnesses, diseases, disorders, symptoms and signs or manifestations of humans or animals such as, but not limited to, swelling, enlargement, tender, lymphadenitis, car accident, tender, whiplash injuries, myocardial infarction, coronary insufficiency, internal medicine, cardiology, fever, sweating, nervousness, palpitations, subacute thyroiditis, endocrinology, bleeding, hemorrhage, migraine, carotodynia, neurology, pericarditis, firm, fluctuant, skin erythema, pustules, acute suppurative thyroiditism, Hashimoto's thyroditis, pressure, Riedel struma, thyroid abscess, malignancies, amyloidosis, abscess.

Furthermore, said system comprises a plurality of medical phrases, terms and terminologies which are synthesized or permutated according to the discovery of this physician applicant. For example, using said words, a pluraltity of phrases, terms, terminology and terminologies can be synthesized or permutated such as, but not limited to, swelling, enlargement, tender, lymphadenitis and internal medicine physician, car accident, tender and whiplash injuries, myocardial infarction, coronary insufficiency and cardiology, fever, sweating, nervousness, palpitations, subacute thyroiditis and endocrinology, bleeding, hemorrhage and emergency medicine physician, migraine, carotodynia and neurology, pericarditis, firm, fluctuant, skin erythema and infectious disease physician, pustules, acute suppurative thyroiditism, Hashimoto's thyroditis, pressure, Riedel struma and endocrinologist . . . including all stems, synonyms and the likes.

From said syntheses and permutations, a pattern and hierarchies of plurality of series, groups, groupings, indexings and matrices of medical words, phrases, terms, and terminologies can be synthesized or permutated. Said pattern and hierarchies intelligently adaptable to render the comparisions, linkings, matchings and sortings of a layperson's or novice's word or words, phrase or phrases, term or terms and terminology or terminologies relating to an illness, a disease and a disorder including symptoms and signs to said plurality of series, groups, groupings, indexings and matrices and vice versa. First, for example, in the most simplistic presentation herein to facilitate understanding and visual localization of words, a layperson presents with a word, a plurality of words, a group or grouping of words such as, but not limited to, swelling, enlargement, pain, tender allows said group or grouping to relate to said system's swelling, enlargement, tender, lymphadenitis and internal medicine physician, car accident, tender and whiplash injuries, myocardial infarction, coronary insufficiency and cardiology, fever, sweating, nervousness, palpitations, subacute thyroiditis and endocrinology, bleeding, hemorrhage and emergency medicine physician, migraine, carotodynia and neurology, pericarditis, firm, fluctuant, skin erythema and infectious disease physician, pustules, acute suppurative thyroiditism, Hashimoto's thyroditis, pressure, Riedel struma and endocrinologist . . . including all stems, synonyms and the likes. Said system also takes into account all layouts, presentations or possible permutations of words, phrases, terms, and terminologies. In other words, for example, the permutations of 4 words are 24 permutations of terms such as 1. swelling, enlargement, pain, tender, 2. swelling, pain, enlargement, tender, 3. tenderness, swelling, pain, enlargement . . . to 24. pain, swelling, enlargement, tender. Second, furthermore, said interaction, i.e. compare, link, match and sort, between said layperson's group or grouping of words and said plurality of series, groups, groupings, indexings and matrices of said system can also be reversed.

Said pattern and hierarchies intelligently adaptable to render a layperson's or novice's word, words, phrase, phrases, term, terms, terminology, terminologies relating to an illness, a disease and a disorder including symptoms and signs to compare, link, match and sort in said plurality of series, groups, groupings, indexings and matrices and vice versa.

To achieve the goals of the present invention, using said pattern and hierarchies of plurality of series, groups, groupings, indexings and matrices of medical words, phrases, terms, and terminologies are synthesized and permutated using the knowledge known only to this physician applicant, said system's vast volume and infinite permutations of medical words, phrases, terms and terminologies relating to health, illnesses, diseases and disorders including symptoms and signs of humans or animals and physicians' demographics relating to illnesses, diseases and disorders are in term-by-documents or term-by-document matrices or patterns. In said matrices or patterns, each medical word, phrase, term or terminology is a vector in the vector space information retrieval model. Furthermore, each medical word, phrase, term or terminology is assigned certain statistical and mathematical weights or importances using statistical and mathematical means such as, but not limited to, Bayesian statistics, probability statatistics in said matrices or patterns. The medical information and knowledge exclusively known only to this physician applicant exclusively permits the document analysis of said words, phrases, terms or terminologies wherein unique words, phrases, terms or terminologies to the documents of said matrices or patterns were assigned. Similarly, the medical information and knowledge exclusively known to this physician applicant exclusively permit the token analysis and item normalization including identification of processing tokens, characterizations of tokens and stemming exclusively by this physician applicant of said words, phrases, terms and terminologies. Said words, phrases, terms and terminologies are assigned specific relevances and associations to relevant said documents of said matrices or patterns.

Said medical information and knowledge permit the rendering of words, phrases, terms and terminologies according to the inverted file structures and signature file structures thereby optimally effectuate the specific and unique relevances and associations of said words, phrases, terms, and terminologies in said series, groups, groupings, indexings and matrices.

Furthermore, said processes including indexings of words, phrases, terms and terminology include conceptual-based indexings and latent semantic indexings.

Although the preferred embodiments have been described, it will be appreciated by those skilled in art that adaptations of the present invention can be had without departing from the spirit of the invention and the scope of the claims.

1. An intelligent system of medical words, phrases, terms and terminologies comprising a pattern and hierarchies of medical words, phrases, terms and terminologies relating to health, illnesses, diseases and disorders of humans or animals wherein a plurality of series, groups, groupings, indexings and matrices of medical words, phrases, terms and terminology intelligently adaptable to render the comparisions, linkings, matchings and sortings of a layperson's or novice's word or words, phrase or phrases, term or terms and terminology or terminologies relating to an illness, a disease, a disorder, symptoms and signs to certain or specific medical words, phrases, terms and terminologies in and to certain group, grouping or index in said plurality of series, groups, groupings, indexings and matrices and vice versa, wherein a layperson's or novice's word, words, phrase, phrases, term, terms, terminology, terminologies is or are intelligently rendered to compare with, link to, match with certain or specific medical words, phrases, terms and terminologies in and to certain group, grouping or index in said plurality of series, groups, groupings, indexings and matrices and to sort in said plurality of series, groups, groupings, indexings and matrices and vice versa, wherein a layperson's or novice's word, words, phrase, phrases, term, terms, terminology, terminologies intelligently adaptable to refer and link to, according to the inverted file structures and signature file structures, certain word, words, phrase, phrases, term, terminology, terminologies in and certain group, grouping or index in said series, groups, groupings, indexings and matrices and vice versa, wherein a layperson's or novice's word, words, phrase, phrases, term, terms, terminology, terminologies is or are intelligently rendered to retrieve certain word, words, phrase, phrases, term, terminology, terminologies, group, groups, grouping, groupings, index or indices from said series, groups, groupings, indexings, matrices and vice versa, and wherein a series, groups, groupings, indexings and matrices of words, phrases, terms and terminologies, group and grouping of words, phrases, terms and terminologies are intelligently empowered to link to, match with and be retrieved by a layperson or novice's word or words, phrase or phrases, term or terms and terminology or terminologies based on a relationship or an association to an illness, a disease, a disorder, symptoms and signs of a human or an animal comprises:
a term-by-document pattern of medical words, phrases, terms and terminologies relating to health, illnesses, diseases and disorders including symptoms and signs of humans or animals;
a term-by-document pattern of medical words, phrases, terms and terminologies relating to health, illnesses, diseases and disorders including symptoms and signs of humans or animals and physicians' demographics relating to said illness, disease or disorder including symptoms and signs;
a plurality of groups of medical words, phrases, terms and terminology wherein each group comprises words, phrases, terms and terminologies relating to an illness, a disease or a disorder including symptoms and signs;
a plurality of groups of medical words, phrases, terms and terminologies wherein each group comprises words, phrases, terms and terminologies relating to an illness, a disease or a disorder including symptoms and signs and physicians' demographics relating to said illness, disease or disorder including symptoms and signs;
a plurality of groupings of medical words, phrases, terms and terminologies wherein each grouping of words, phrases, terms and terminologies relating to an illness, a disease or a disorder including symptoms and signs;
a plurality of groupings of medical words, phrases, terms and terminologies wherein each grouping of words, phrases, terms and terminologies relating to an illness, a disease or a disorder including symptoms and signs and physicians' demographics relating to said illness, disease or disorder including symptoms and signs;
a series of medical words, phrases, terms and terminologies relating to an illness, a disease and a disorder including symptoms and signs;
a plurality of series of medical medical words, phrases, terms and terminologies wherein a series of words, phrases, terms and terminologies relating to an illness, a disease or a disorder including symptoms and signs;
a plurality of series of medical medical words, phrases, terms and terminologies wherein a series of words, phrases, terms and terminologies relating to an illness, a disease or a disorder including symptoms and signs and physicians' demographics relating to said illness, disease or disorder including symptoms and signs;
an indexing of medical words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs and physicians' demographics relating to said illness, disease or disorder including symptoms and signs;
said word, phrase, term or terminology is a vector in the vector space information retrieval model;
said words, phrases, terms or terminologies are vectors in the vector space information retrieval model.

2. The system according to claim 1 wherein said indexings of words, phrases, terms and terminology includes conceptual-based indexing.

3. The conceptual-based indexing according to claim 2 includes latent semantic indexing.

4. The system according to claim 1 comprises document analysis of words, phrases, terms and terminologies.

5. The system according to claim 1 comprises token analysis of words, phrases, terms and terminologies.

6. The decipherment of a certain or specific pattern of medical words, phrases, terms, terminology and terminologies comprising certain or specific hierarchies of medical words, phrases, terms, terminology and terminologies relating to health, illnesses, diseases and disorders of humans or animals wherein a plurality of series, groups, groupings, indexings and matrices of medical words, phrases, terms and terminology intelligently adaptable to render the comparisions, linkings, matchings and sortings of a layperson's or novice's word or words, phrase or phrases, term or terms and terminology or terminologies relating to an illness, a disease, a disorder, symptoms and signs to certain or specific medical words, phrases, terms and terminologies in and to certain group, grouping or index in said plurality of series, groups, groupings, indexings and matrices and vice versa, wherein a layperson's or novice's word, words, phrase, phrases, term, terms, terminology, terminologies is or are intelligently rendered to compare with, link to, match with certain or specific medical words, phrases, terms and terminologies in and to certain group, grouping or index in said plurality of series, groups, groupings, indexings and matrices and to sort in said plurality of series, groups, groupings, indexings and matrices and vice versa, wherein a layperson's or novice's word, words, phrase, phrases, term, terms, terminology, terminologies intelligently adaptable to refer and link to, according to the inverted file structures and signature file structures, certain word, words, phrase, phrases, term, terminology, terminologies in and certain group, grouping or index in said series, groups, groupings, indexings and matrices and vice versa, wherein a layperson's or novice's word, words, phrase, phrases, term, terms, terminology, terminologies is or are intelligently rendered to retrieve certain word, words, phrase, phrases, term, terminology, terminologies, group, groups, grouping, groupings, index or indices from said series, groups, groupings, indexings, matrices and vice versa, and wherein a series, groups, groupings, indexings and matrices of words, phrases, terms and terminologies, group and grouping of words, phrases, terms and terminologies are intelligently empowered to link to, match with and be retrieved by a layperson or novice's word or words, phrase or phrases, term or terms and terminology or terminologies based on a relationship or an association to an illness, a disease, a disorder, symptoms and signs of a human or an animal comprises:
a term-by-document pattern of medical words, phrases, terms and terminologies relating to health, illnesses, diseases and disorders including symptoms and signs of humans or animals;
a term-by-document pattern of medical words, phrases, terms and terminologies relating to health, illnesses, diseases and disorders including symptoms and signs of humans or animals and physicians' demographics relating to said illness, disease or disorder including symptoms and signs;
a plurality of groups of medical words, phrases, terms and terminology wherein each group comprises words, phrases, terms and terminologies relating to an illness, a disease or a disorder including symptoms and signs;
a plurality of groups of medical words, phrases, terms and terminologies wherein each group comprises words, phrases, terms and terminologies relating to an illness, a disease or a disorder including symptoms and signs and physicians' demographics relating to said illness, disease or disorder including symptoms and signs;
a plurality of groupings of medical words, phrases, terms and terminologies wherein each grouping of words, phrases, terms and terminologies relating to an illness, a disease or a disorder including symptoms and signs;
a plurality of groupings of medical words, phrases, terms and terminologies wherein each grouping of words, phrases, terms and terminologies relating to an illness, a disease or a disorder including symptoms and signs and physicians' demographics relating to said illness, disease or disorder including symptoms and signs;
a series of medical words, phrases, terms and terminologies relating to an illness, a disease and a disorder including symptoms and signs;
a plurality of series of medical medical words, phrases, terms and terminologies wherein a series of words, phrases, terms and terminologies relating to an illness, a disease or a disorder including symptoms and signs;
a plurality of series of medical medical words, phrases, terms and terminologies wherein a series of words, phrases, terms and terminologies relating to an illness, a disease or a disorder including symptoms and signs and physicians' demographics relating to said illness, disease or disorder including symptoms and signs;
an indexing of medical words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs and physicians' demographics relating to said illness, disease or disorder including symptoms and signs;
said word, phrase, term or terminology is a vector in the vector space information retrieval model;
said words, phrases, terms or terminologies are vectors in the vector space information retrieval model.

7. A discovery of a certain or specific pattern of medical words, phrases, terms, terminology and terminologies comprising certain or specific hierarchies of medical words, phrases, terms, terminology and terminologies relating to health, illnesses, diseases and disorders of humans or animals wherein a plurality of series, groups, groupings, indexings and matrices of medical words, phrases, terms and terminology intelligently adaptable to render the comparisions, linkings, matchings and sortings of a layperson's or novice's word or words, phrase or phrases, term or terms and terminology or terminologies relating to an illness, a disease, a disorder, symptoms and signs to certain or specific medical words, phrases, terms and terminologies in and to certain group, grouping or index in said plurality of series, groups, groupings, indexings and matrices and vice versa, wherein a layperson's or novice's word, words, phrase, phrases, term, terms, terminology, terminologies is or are intelligently rendered to compare with, link to, match with certain or specific medical words, phrases, terms and terminologies in and to certain group, grouping or index in said plurality of series, groups, groupings, indexings and matrices and to sort in said plurality of series, groups, groupings, indexings and matrices and vice versa, wherein a layperson's or novice's word, words, phrase, phrases, term, terms, terminology, terminologies intelligently adaptable to refer and link to, according to the inverted file structures and signature file structures, certain word, words, phrase, phrases, term, terminology, terminologies in and certain group, grouping or index in said series, groups, groupings, indexings and matrices and vice versa, wherein a layperson's or novice's word, words, phrase, phrases, term, terms, terminology, terminologies is or are intelligently rendered to retrieve certain word, words, phrase, phrases, term, terminology, terminologies, group, groups, grouping, groupings, index or indices from said series, groups, groupings, indexings, matrices and vice versa, and wherein a series, groups, groupings, indexings and matrices of words, phrases, terms and terminologies, group and grouping of words, phrases, terms and terminologies are intelligently empowered to link to, match with and be retrieved by a layperson or novice's word or words, phrase or phrases, term or terms and terminology or terminologies based on a relationship or an association to an illness, a disease, a disorder, symptoms and signs of a human or an animal comprises:
a term-by-document pattern of medical words, phrases, terms and terminologies relating to health, illnesses, diseases and disorders including symptoms and signs of humans or animals;
a term-by-document pattern of medical words, phrases, terms and terminologies relating to health, illnesses, diseases and disorders including symptoms and signs of humans or animals and physicians' demographics relating to said illness, disease or disorder including symptoms and signs;
a plurality of groups of medical words, phrases, terms and terminology wherein each group comprises words, phrases, terms and terminologies relating to an illness, a disease or a disorder including symptoms and signs;
a plurality of groups of medical words, phrases, terms and terminologies wherein each group comprises words, phrases, terms and terminologies relating to an illness, a disease or a disorder including symptoms and signs and physicians' demographics relating to said illness, disease or disorder including symptoms and signs;
a plurality of groupings of medical words, phrases, terms and terminologies wherein each grouping of words, phrases, terms and terminologies relating to an illness, a disease or a disorder including symptoms and signs;
a plurality of groupings of medical words, phrases, terms and terminologies wherein each grouping of words, phrases, terms and terminologies relating to an illness, a disease or a disorder including symptoms and signs and physicians' demographics relating to said illness, disease or disorder including symptoms and signs;
a series of medical words, phrases, terms and terminologies relating to an illness, a disease and a disorder including symptoms and signs;
a plurality of series of medical medical words, phrases, terms and terminologies wherein a series of words, phrases, terms and terminologies relating to an illness, a disease or a disorder including symptoms and signs;
a plurality of series of medical medical words, phrases, terms and terminologies wherein a series of words, phrases, terms and terminologies relating to an illness, a disease or a disorder including symptoms and signs and physicians' demographics relating to said illness, disease or disorder including symptoms and signs;
an indexing of medical words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs;
indexings of medical words, phrases, terms and terminologies wherein each indexing of words, phrases, terms and terminologies relating to an illness, a disease or a disorder including symptoms and signs and physicians' demographics relating to said illness, disease or disorder including symptoms and signs;
said word, phrase, term or terminology is a vector in the vector space information retrieval model;
said words, phrases, terms or terminologies are vectors in the vector space information retrieval model.
